(19) United States
(12) Patent Application Publication
(10) Pub. No.: US 2024/0161000 A1
(43) Pub. Date: May 16, 2024

(54) ARTIFICIAL INTELLIGENCE-BASED SUSTAINABILITY CONTROL

(71) Applicant: INTERNATIONAL BUSINESS MACHINES CORPORATION, Armonk, NY (US)

(72) Inventors: Gary ZASMAN, Boulder, CO (US); Mansura HABIBA, Jhonstown (IE); Rafflesia KHAN, Dublin (IE)

(21) Appl. No.: 18/055,876

(22) Filed: Nov. 16, 2022

(51) Int. Cl. G06N 20/00

(52) U.S. Cl. CPC G06N 20/00

(57) ABSTRACT

Autonomous sustainability control is provided related to performing a functional objective. Normalized data is obtained from heterogeneous data obtained from a plurality of data sources, where the heterogeneous data is related, at least in part, to the functional objective. The normalized data is used to train an artificial intelligence model to learn dynamic key performance indicators relating, at least in part, performance of the functional objective to sustainability. The artificial intelligence model is used to learn a set of dynamic key performance indicators to relate current performance of the functional objective to sustainability. The learned set of dynamic key performance indicators is used to identify an anomaly, and one or more corrective actions are generated to remediate a risk associated with the anomaly. The one or more actions facilitate the autonomous sustainability control related to performing the functional objective.

### BACKGROUND

One or more aspects relate, in general, to artificial intelligence-based processing, and in particular, to artificial intelligence-based sustainability control driven by learned dynamic key performance indicators related to functional objective performance.

A performance indicator, or key performance indicator, is a performance measurement used to evaluate a functional objective or operational goal of, for instance, a system, a computing environment, a physical asset, etc. Key performance indicators can provide data for strategic and operational improvement in performing the functional objective. By way of example, a functional objective of a cloud-supporting data center can be processing reliability of the data center, including processing availability, processing speed, etc. Conventionally, key performance indicators are statically-chosen indicators which support performance evaluation of the functional objective.

Sustainability, or environmental sustainability, is typically separately considered from evaluation of functional objective performance. Cloud-based processing can reduce environmental impact by taking advantage of shared resources, such as networking, power, cooling, and physical facilities. In one example, sustainability of a cloud-supporting data center can relate to controlling, for instance, energy usage within the data center. For instance, efficiency of a data center can be enhanced using more efficient power and cooling technologies, more efficient server populations, achieving higher server utilization rates, etc.

### SUMMARY

Shortcomings of the prior art are overcome, and additional advantages are provided through the provision of a computer-implemented method of autonomous sustainability control related to performing a functional objective. The computer-implemented method includes obtaining normalized data from heterogeneous data obtained from a plurality of data sources. The heterogeneous data relates, at least in part, to the functional objective. The method further includes training, using the normalized data, an artificial intelligence model to learn dynamic key performance indicators relating, at least in part, performance of the functional objective to sustainability, and using the artificial intelligence model to learn a set of dynamic key performance indicators to relate current performance of the functional objective to sustainability. Further, the computer-implemented method includes identifying, using the learned set of dynamic key performance indicators, an anomaly, and generating one or more corrective actions to remediate a risk associated with the anomaly. The one or more corrective actions facilitate the autonomous sustainability control related to performing the functional objective.

Advantageously, improved processing within a computing environment is provided, including improved sustainability control of a system or a plurality of systems. An artificial intelligence-based sustainability control process is provided, driven by learned dynamic key performance indicators related to functional objective performance. The computer-implemented method, in part, learns the dynamic key performance indicators relating, at least in part, performance of the functional objective to sustainability. Additionally, the computer-implemented method identifies, using the learned set of dynamic key performance indicators, an anomaly and generates one or more corrective actions to remediate a risk associated with the anomaly, converting detecting of the anomaly into a remediating action.

In one implementation, obtaining normalized data includes classifying, at least in part, the heterogeneous data into classified data. Classifying the heterogeneous data facilitates identifying similarities and differences which can facilitate defining a single normalized data format for the heterogeneous data.

In one implementation, obtaining normalized data from the heterogeneous data further includes normalizing the classified data by simplifying the classified data and generating a virtual data model representative of a simplified version of the heterogeneous data, and normalizing the virtual data model using, at least in part, functional objective relation data.

In one example, identifying, using the learned set of dynamic key performance indicators, the anomaly, further includes using the learned set of dynamic key performance indicators to detect an anomaly in the normalized data, and based on detecting the anomaly, identifying an incident and predicting an associated risk to sustainability and performance of the functional objective.

In one or more embodiments, the method further includes automatically establishing a relationship between the incident, the predicted risk, and the underlying cause to generate a root cause analysis for one or more different risks and incidents.

In one or more implementations, the method includes optimizing the artificial intelligence-based model by, at least in part, feeding identification of the incident back to the training of the artificial intelligence model to optimize learning of the set of dynamic key performance indicators. In one or more further embodiments, the optimizing of the artificial intelligence model includes, at least in part, feeding an output of the root cause analysis back to the training of the artificial intelligence model to optimize learning of the set of dynamic key performance indicators.

In one or more embodiments, generating the one or more actions includes using the output of the root cause analysis and the learned set of dynamic key performance indicators to autonomously generate the one or more actions.

In one example, the method further includes executing autonomously the one or more actions to make one or more real-time changes to remediate the risk and facilitate reaching a desired sustainability state. Advantageously, executing autonomously the one or more actions facilitates autonomous sustainability control, notwithstanding changing sustainability data, demands, or goals.

In one or more embodiments, the heterogeneous data is obtained from a plurality of systems, where the normalized data is obtained with swarm intelligence. The use of swarm intelligence advantageously enhances the normalized data, and thereby improves the sustainability control.

In another aspect, a computer system for facilitating autonomous sustainability control related to performing a functional objective is provided. The computer system includes a memory, and at least one processor in communication with the memory. The computer system is configured to perform a method, which includes obtaining normalized data from heterogeneous data obtained from a plurality of data sources. The heterogeneous data relates, at least in part, to the functional objective. The method further includes training, using the normalized data, an artificial intelligence model to learn dynamic key performance indicators relating, at least in part, performance of the functional objective to sustainability, and using the artificial intelligence model to learn a set of dynamic key performance indicators to relate current performance of the functional objective to sustainability. Further, the computer-implemented method includes identifying, using the learned set of dynamic key performance indicators, an anomaly, and generating one or more corrective actions to remediate a risk associated with the anomaly. The one or more corrective actions facilitate the autonomous sustainability control related to performing the functional objective.

In a further aspect, a computer program product for facilitating autonomous sustainability control related to performing a functional objective is provided. The computer program product includes one or more computer-readable storage media and program instructions collectively stored on the one or more computer-readable storage media readable by at least one processing circuit to perform a method, which includes obtaining normalized data from heterogeneous data obtained from a plurality of data sources. The heterogeneous data relates, at least in part, to the functional objective. The method further includes training, using the normalized data, an artificial intelligence model to learn dynamic key performance indicators relating, at least in part, performance of the functional objective to sustainability, and using the artificial intelligence model to learn a set of dynamic key performance indicators to relate current performance of the functional objective to sustainability. Further, the computer-implemented method includes identifying, using the learned set of key performance indicators, an anomaly, and generating one or more corrective actions to remediate a risk associated with the anomaly. The one or more corrective actions facilitate the autonomous sustainability control related to performing the functional objective.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2 depicts one embodiment of a computer program product containing a sustainability control module, in accordance with one or more aspects of the present invention;

FIG. 3 depicts one embodiment of a sustainability control workflow, in accordance with one or more aspects of the present invention;

FIG. 4 depicts one example of a data center functional objective and a sustainability control process, in accordance with one or more aspects of the present invention;

FIG. 5 depicts another example of a sustainability control workflow, in accordance with one or more aspects of the present invention;

FIG. 6 depicts another example of a computing environment to incorporate and/or use one or more aspects of the present invention;

FIG. 7 depicts another example of a computing environment and sustainability control workflow, in accordance with one or more aspects of the present invention;

FIG. 8 depicts a further example of a computing environment and sustainability control workflow, in accordance with one or more aspects of the present invention;

FIG. 9 depicts one example of data normalization workflow, in accordance with one or more aspects of the present invention; and

FIG. 10 depicts one embodiment of dynamic key performance indicator generator workflow, in accordance with one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, or tools only as examples, and not by way of limitation. Furthermore, the illustrative embodiments are described in certain instances using particular software, hardware, tools, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

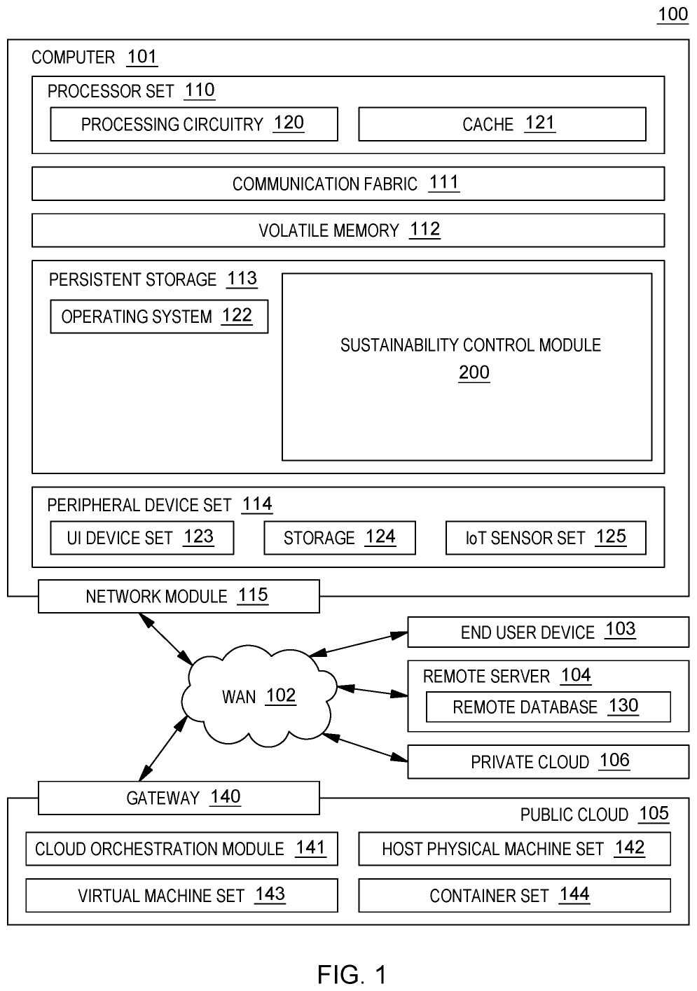

As understood by one skilled in the art, program code, as referred to in this application, can include software and/or hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1, including operating system 122 and sustainability control module 200, which are stored in persistent storage 113.

One or more aspects of the present invention are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform automated sustainability control or management related to performing one or more functional objectives. Aspects of the present invention are not limited to a particular architecture or environment.

Prior to further describing detailed embodiments of the present invention, an example of a computing environment to include and/or use one or more aspects of the present invention is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as sustainability control module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. Further, in one or more embodiments, one or more of the components/modules of FIG. 1 need not be included in the computing environment and/or are not used for one or more aspects of the present invention. Further, in one or more embodiments, additional and/or other components/modules can be used. Other variations are possible.

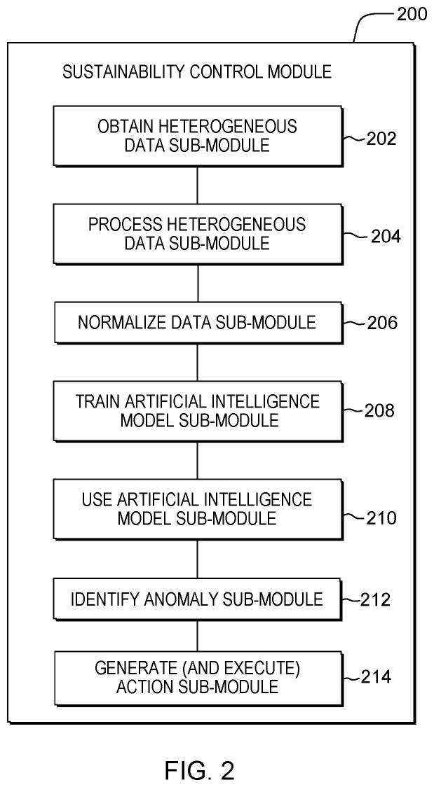

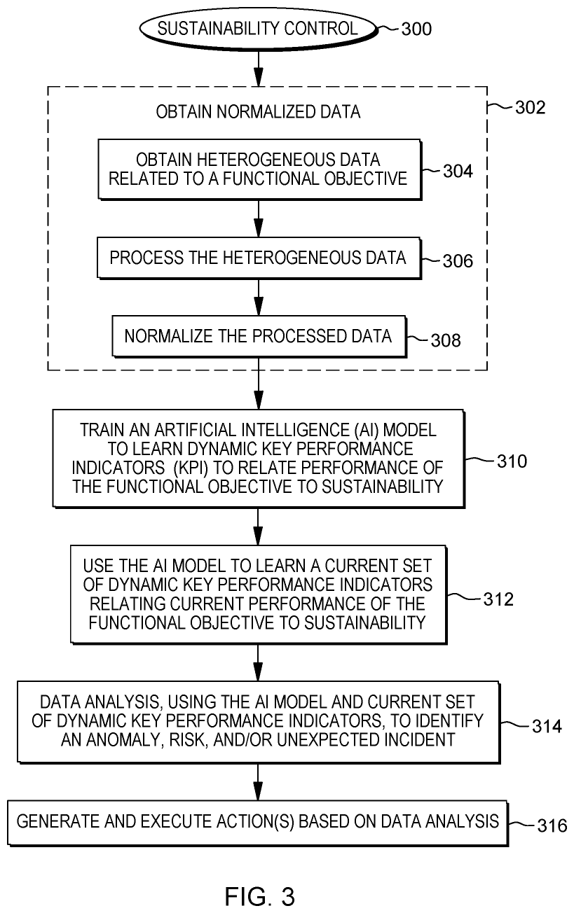

By way of example, embodiments of automated, artificial intelligence-based sustainability control in association with performing one or more functional objectives are described with reference to FIGS. 2-3. FIG. 2 depicts further details of a sustainability control module 200 that includes code or instructions used to perform automated sustainability control, in accordance with one or more aspects of the present invention, and FIG. 3 depicts one embodiment of a process to perform sustainability control related to performing one or more functional objectives, in accordance with one or more aspects of the present invention.

Referring to FIGS. 1 & 2, in one or more aspects, sustainability control module 200 includes, in one example, various sub-modules to be used to perform automated sustainability control in association with performing a functional objective. Note that although discussed herein as being in association with performing a functional objective, the automated sustainability control can be in association with performing one or more functional objectives, depending on the implementation. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

As shown in the FIG. 2 embodiment, example sub-modules of sustainability control module 200 include, for instance, an obtain heterogeneous data sub-module 202 to obtain heterogeneous data from a plurality of data sources, where the heterogeneous data relates, at least in part, to the functional objective; a process heterogeneous data sub-module 204 to process the heterogeneous data to obtain processed data, where the processing can include classifying the heterogeneous data into classified data; normalize data sub-module 206 to normalize the processed data to obtain normalized data; and train artificial intelligence model sub-module 208 to train, using the normalized data, an artificial intelligence model to learn a set of dynamic key performance indicators to relate current performance of the functional objective to sustainability. Additionally, sustainability control module 200 includes, in one example, a use artificial intelligence model sub-module 210 to learn a set of dynamic key performance indicators to relate current performance of the functional objective to sustainability; an identify anomaly sub-module 212 to identify, using the learned set of dynamic key performance indicators, an anomaly; and a generate action sub-module 214 to generate one or more corrective actions to remediate a risk associated with the anomaly, where the one or more corrective actions facilitate sustainability control related to performing the functional objective. Note that although various sub-modules are described, automated sustainability control such as disclosed herein can include additional, fewer, and/or different sub-modules. A particular sub-module can include additional code, including code of other sub-modules, or less code. Further, additional and/or other modules can be used. Many variations are possible.

In one or more embodiments, the sub-modules are used, in accordance with one or more aspects of the present invention, to perform automated sustainability control related to or associated with performing a functional objective, such as described herein.

FIG. 3 depicts one example of a process of automated sustainability control 300, in accordance with one or more aspects of the present invention. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as sustainability control module 200. In other examples, the code can be included in one or more other modules and/or in one or more sub-modules of the one or more other modules. Various options are available.

As one example, sustainability control process 300 executing on a computer (e.g., computer 101 of FIG. 1), a processor (e.g., a processor of processor set 110 of FIG. 1) and/or processing circuitry (e.g., processing circuitry of processor set 110), obtains normalized data 302, which in one embodiment, can include obtaining heterogeneous data related to a functional objective of a system or environment, such as a computing environment 304. The heterogeneous data can be obtained from a plurality of data sources (e.g., sensors, Internet of Thing (IoT) devices, monitors, systems, etc.) and relate, at least in part, to the functional objective (such as ensuring processing reliability within a data center, or ensuring presence of a required level of processing support for an executing application, etc.). In one embodiment, obtaining normalized data 302 also includes processing the heterogeneous data to obtain processed data 306. For instance, processing the heterogeneous data can include classifying the heterogeneous data into multiple categories of data. Further, obtaining the normalized data can include, in one embodiment, normalizing the processed data 308, which can include (in one embodiment) simplifying the processed data and generating a virtual data model representative of a simplified version of the heterogeneous data, and normalizing the virtual data model using, at least in part, functional objective relation data to obtain the normalized data.

As illustrated in FIG. 3, sustainability control processing 300 further includes, in one or more aspects, training an artificial intelligence model to learn dynamic key performance indicators relating, at least in part, performance of the functional objective to sustainability 310. For instance, dynamic key performance indicators can be application-dependent. For a data center implementation, key performance indicators can include percentage of carbon emission, or carbon footprint, energy efficiency of the data center, percentage of sustainable energy usage, percentage of renewable energy usage, air pressure within the data center, energy consumption of applications executing within the data center, emissions of the data center, emissions savings for the data center, emissions by geographic location of the data center, emissions by each processing service executing within the data center, etc. Further, sustainability control processing 300 includes, in one embodiment, using the artificial intelligence model to learn a set of dynamic key performance indicators to relate current performance of the functional objective to sustainability 312. In addition, in one or more embodiments, sustainability control processing 300 includes data analysis identifying, using the learned set of dynamic key performance indicators (KPIs), of an anomaly related to the functional objective or sustainability 314, and generating one or more corrective actions to remediate a risk associated with the anomaly based on the data analysis 316. The one or more corrective actions facilitate autonomous sustainability control in performing the functional objective.

In one or more aspects, based on generating the one or more corrective actions to remediate risk associated with an anomaly, the one or more actions are implemented. For instance, a maintenance action (e.g., repair, replace, maintain and/or inspect, etc.) specified in the action can be initiated for a selected environment (e.g., computing environment, manufacturing environment, utility environment, construction environment, etc.). In one example, an action is initiated by sending (e.g., automatically based on the generating) an indication to commence the action. As an example, the action can be initiated by a computer (e.g., computer 101 (FIG. 1)), a processor of a processor set (e.g., processor set 110) and/or processing circuitry of a processor set (e.g., processor set 110), to a computing resource, electronic component, device, etc., of the environment that receives the indication and automatically initiates performance of the action. Alternatively, or additionally, an indication can be sent to an operator or other entity that oversees the system or environment.

Based on initiating a generated action, the action is performed. As examples, a physical component within a computing environment can be inspected, maintained, repaired and/or replaced. This can be performed manually and/or automatically (e.g., using computer code, a robotic device, etc.). Many possibilities exist.

Evaluation of functional objective performance and sustainability control (or management) are conventionally handled separately using, for instance, separate, single-subject-focused data analytics, resulting in a set of individual systems to process each type of data. As a result, a large and diverse dataset is created, making it difficult to generate an appropriate set of goals. In another approach, sustainability control can be addressed by setting or predefining a sustainability goal parameter, such as a carbon footprint. The issue with this approach is that the system is focused on a predefined objective, and scope never changes. It is difficult for the system to be autonomous and change dynamically with a dynamic environment in such a case. Rather than scoping objectives initially, the artificial intelligence-based sustainability control disclosed herein leverages one or more objectives (e.g., key performance indicators) as seeds, and then enhances the key performance indicators over time with learned intelligence.

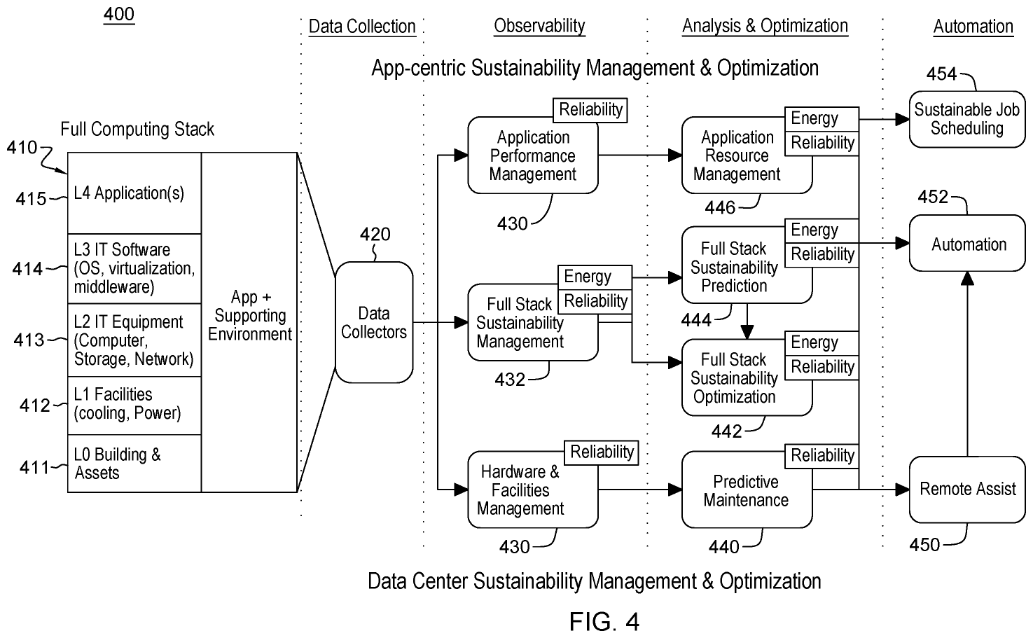

Although typically considered separate from evaluation of functional objective performance, sustainability control or management can complement control of one or more functional objectives. FIG. 4 depicts one example of a data center environment 400 with functional objective management and sustainability control and optimization. In this example, data center environment 400 includes one or more computing racks or stacks 410 which include different layers of technology to be monitored and controlled, for instance, to achieve both a functional objective and manage a sustainability state or goal for the data center environment. In the example of FIG. 4, the layers of the computing stack 410 include layer 0, which includes building and physical assets 411, layer 1, containing data center facilities such as cooling and power 412, layer 2, with computing or information technology (IT) equipment (computer systems, storage, network, etc.) 413, layer 3, consisting of software (such as operating system, virtualization, middleware, etc.) 414, and layer 4, including applications (such as one or more enterprise applications) 415.

Data is collected 420 via a plurality of data sources, such as a plurality of heterogeneous sensors, systems, monitors, etc., which collect and provide heterogeneous data for analysis. In the example illustrated, the data is used for hardware and facilities management 430, full-stack sustainability management 430, and application performance management 434. In the depicted example, processing reliability is an example functional objective, and energy usage is an example sustainability parameter. In one embodiment, data analysis and optimization includes processing to predict maintenance requirements for reliability 440, full-stack sustainability optimization 442, full-stack sustainability prediction 440, and application resource management 446, with functional objective performance and sustainability control shown related for application resource management 446, full-stack sustainability prediction 444, and full-stack sustainability optimization 442. In one or more embodiments, the system is an artificial intelligence-based system, and can include, in one or more aspects, automation to implement, for instance, one or more actions generated as a result of, and/or to facilitate, sustainability control (or management) and performance of the functional objective. The automation can include, for instance, providing an operator or technician with remote assist data to assist with, for instance, a maintenance action (e.g., repair, replace, maintain and/or inspect, etc.). Further, in one or more embodiments, one or more actions can be executed autonomously to make, for instance, one or more real-time changes to one or more components of the data center to, for instance, execute the sustainability control. For instance, in one embodiment, one or more processing jobs to be processed can be scheduled to facilitate sustainability 454. Note that FIG. 4 represents one example only of an environment within which autonomous sustainability control related to, or in association with, performing a functional objective, such as described herein, can be implemented.

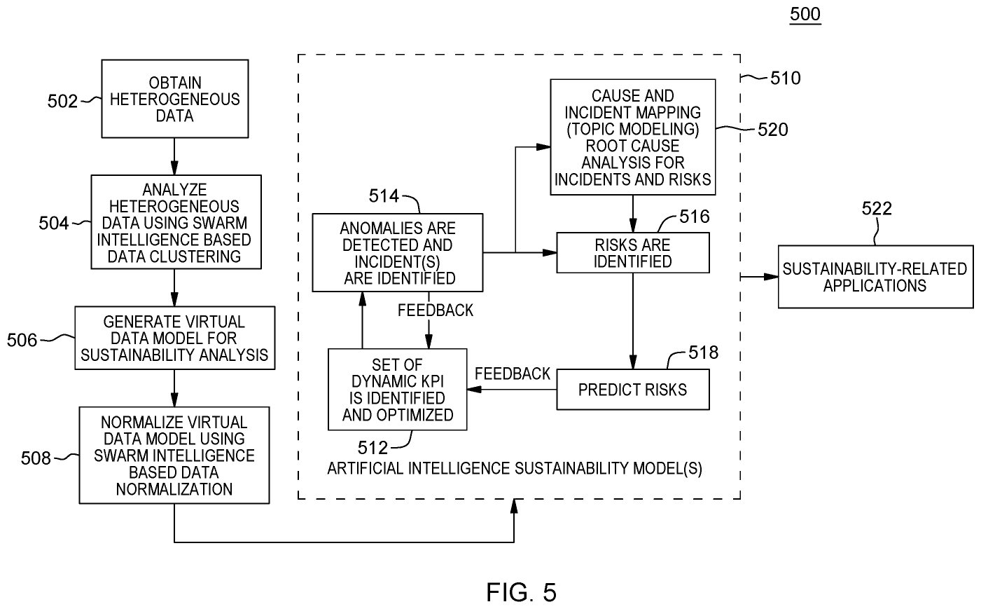

FIG. 5 depicts another example of a sustainability control process 500 related to performing a functional objective, in accordance with one or more aspects of the present invention. In one or more embodiments, sustainability control process 500 has or references one or more computer-implemented agents to obtain heterogeneous data from a plurality of heterogeneous data sources 502. The obtained heterogeneous data is analyzed, in one or more implementations, using swarm intelligence-based data clustering processing 504, for instance, to identify patterns and relationships in the heterogeneous data and/or heterogeneous data sources, rather than processing the obtained data individually. Note that, as used herein, swarm intelligence refers to an environment where multiple systems provide data and/or knowledge to facilitate, for instance, one or more of the artificial intelligence-based processes described. Once clustered into categories, the clustered data can be processed (in one embodiment) into a virtual data model for sustainability analysis 506. For instance, in normalizing cluster data, similar features can be identified. A data simplifier can combine these similar features, and then construct a comprehensive feature layer or model. Uncommon features can be grouped by relationship and used to construct a second generation of features. For unique unrelated features, the model can apply weights to determine whether these should be considered as noise, or combined with nearby clusters. Simplified clusters can then be used to generate virtual data models or swarm intelligence models. Using the virtual data model(s), swarm intelligence-based data normalization processing is used to normalize the data 508. Through data normalization methods, the artificial intelligence model continuously improves model performance and generates knowledge.

The knowledge can be provided to one or more artificial intelligence sustainability model(s) 510, which use the data and knowledge to learn a set of dynamic key performance indicators to relate current performance of a functional objective to sustainability 512. Once the artificial intelligence model(s) 510 has learned a set of (optimized) dynamic key performance indicators relating current performance of the functional objective to sustainability, the artificial intelligence model(s) 510 can feed the indicators to a data analyzer for use in identifying or detecting any anomalies and/or incidents 514 in the normalized data. Further, one or more risks can be identified 516 by the artificial intelligence model(s) 510, based on any anomalies, and/or one or more risks can be identified or predicted 518, with the identified and/or predicted risks being fed back as part of the knowledge base from which the system learns the set of dynamic key performance indicators relating performance of the functional objective to sustainability 512. In addition, cause and incident mapping (e.g., topic modeling) can be used in one or more embodiments to perform root cause analysis for incident and risk analysis 520. The output of the root cause analysis can be fed to one or more sustainability-related applications 522 for, for instance, generating one or more actions to remediate a risk associated with a detected anomaly. In one or more embodiments, the sustainability-related control applications 522 can execute autonomously the one or more actions to make one or more real-time changes to remediate the risk and facilitate reaching a desired sustainability state or goal. In addition to identifying or predicting risk, the artificial intelligence model's collective insights and formed intelligence can help in executing proficient actions to remediate a risk. As described herein, in one or more embodiments, a continuous monitoring and governance process can be implemented to enhance performance of the artificial intelligence model(s).

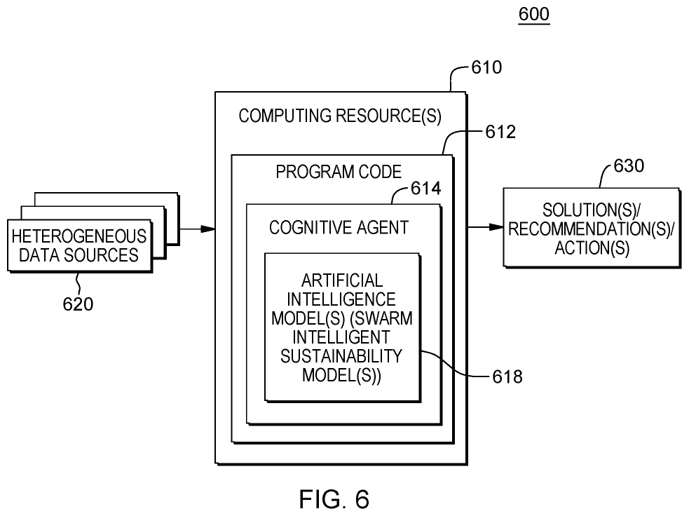

Before further describing one or more embodiments of artificial intelligence sustainability control such as disclosed herein, including one or more artificial intelligence sustainability model(s), FIG. 6 depicts another embodiment of a computing environment or system 600, which can incorporate, or implement, one or more aspects of an embodiment of the present invention. In one or more implementations, system 600 can be part of a computing environment, such as computing environment 100 described above in connection with FIG. 1. System 600 includes one or more computing resources 610 that execute program code 612 that implements, for instance, an artificial intelligence-based sustainability control module or facility, and which includes a cognitive engine or agent 614, which utilizes one or more artificial intelligence models 618, such as described herein. Data, such as the heterogeneous data discussed herein, is used by cognitive agent 614, to train model(s) 618, to (for instance) control or manage sustainability to a desired, set goal in association with performing one or more functional objectives, and to generate one or more recommendations and/or actions 630, etc., based on the particular application of the machine-learning model to facilitate achieving the sustainability goal. In implementation, system 600 can include, or utilize, one or more networks for interfacing various aspects of computing resource(s) 610, as well as one or more data sources 620 providing data, and one or more systems receiving an output action, etc., 630 of artificial intelligence model(s) 618. By way of example, the network(s) can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, and an output solution, recommendation, action, of the machine-learning model, such as discussed herein.

In one or more implementations, computing resource(s) 610 houses and/or executes program code 612 configured to perform methods in accordance with one or more aspects of the present invention. By way of example, computing resource(s) 610 can be a computing-system-implemented resource(s). Further, for illustrative purposes only, computing resource(s) 610 in FIG. 6 is depicted as being a single computing resource. This is a non-limiting example of an implementation. In one or more other implementations, computing resource(s) 610, by which one or more aspects of artificial intelligence-based sustainability control processing such as discussed herein is implemented, can, at least in part, be implemented in multiple separate computing resources or systems, such as one or more computing resources of a cloud-hosting environment, by way of example.

Briefly described, in one embodiment, computing resource(s) 610 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed herein are described further herein with reference to FIG. 1, as well as with reference to FIG. 6.

As noted, program code 612 executes, in one implementation, a cognitive engine or agent 614 which includes and trains one or more models 618. The models can be trained using training data that can include a variety of types of data, depending on the model and the data sources. In one or more embodiments, program code 612 executing on one or more computing resources 610 applies one or more algorithms of cognitive agent 614 to generate and train the model(s), which the program code then utilizes to identify an anomaly and predict a risk associated therewith, and depending on the application, to perform an action (e.g., provide a solution, make a recommendation, perform a task, etc.). In an initialization or learning stage, program code 612 trains one or more artificial intelligence-based sustainability models 618 using obtained training data that can include, in one or more embodiments, normalized data and seed data such as described herein.

Data used to train the model (in one or more embodiments of the present invention) can include a variety of types of data, such as heterogeneous data generated by a plurality of data sources and/or data stored in one or more databases or data lakes of, or accessible by, the computing resource(s). Program code, in embodiments of the present invention, can perform data analysis to generate data structures, including algorithms utilized by the program code to predict and/or perform an action. As known, artificial intelligence-based modeling solves problems that cannot be solved by numerical means alone. In one example, program code extracts features/attributes from training data, which can be stored in memory or one or more databases. The extracted features can be utilized to develop a predictor function, h(x), also referred to as a hypothesis, which the program code utilizes as a model. In identifying artificial intelligence model(s) 618, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present invention, the program code can utilize a neural network to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

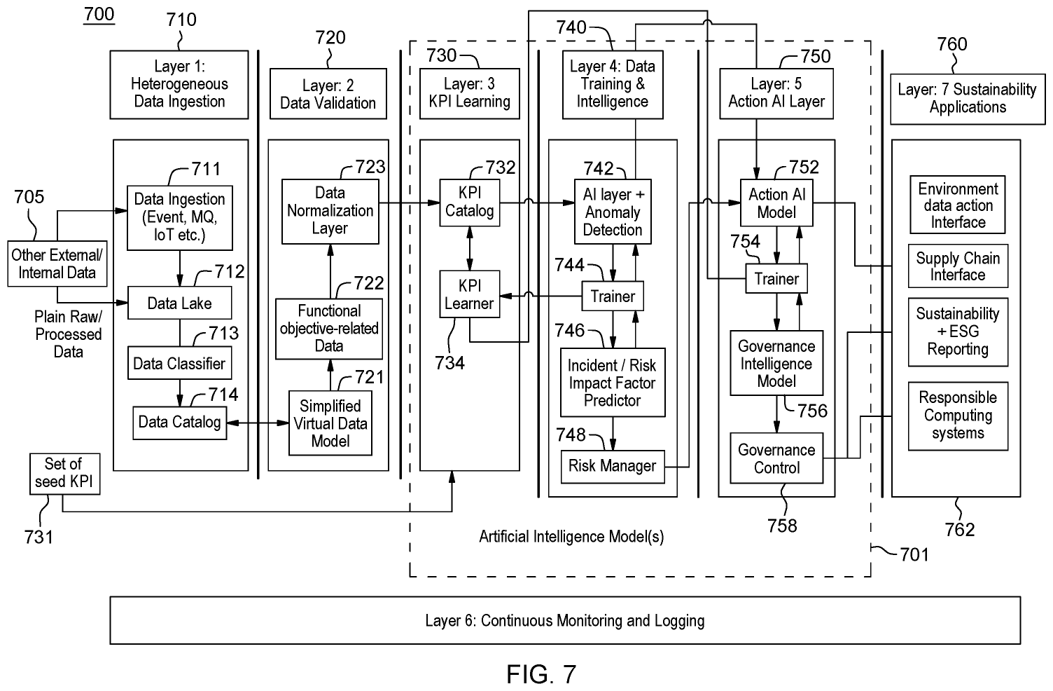

By way of example, FIG. 7 depicts a more detailed embodiment of a computing environment with sustainability control processing 700, such as described above in connection with FIGS. 5-6, in accordance with one or more aspects of the present invention. The computing environment can include or execute on one or more computing resources, such as those described above in connection with FIGS. 1 & 6, by way of example. In the sustainability control process of FIG. 7, multiple layers or modules are illustrated, each including program code to perform one or more aspects described herein. For instance, in the example of FIG. 7, the sustainability control processing includes seven layers, by way of example only, with layer 1 performing a heterogeneous data ingestion 710, layer 2 including data validation and/or normalization 720, layer 3 being key performance indicator learning 730, layer 4 being data-based model training and intelligence-based anomaly detection 740, layer 5 being artificial intelligence-based action layer 750, layer 6 being a continuous monitoring and logging layer, and layer 7 being sustainability-related applications 760.

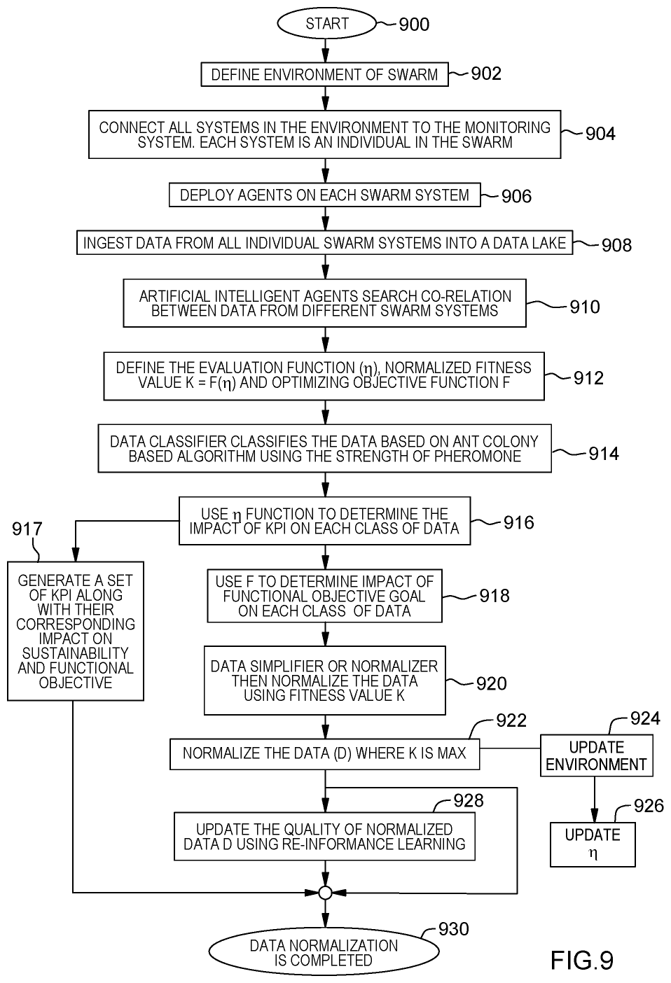

As illustrated, layer 1 heterogeneous data ingestion 720 includes ingestion of data from a plurality of heterogeneous data sources 705, such as event data sources, messaging and queuing infrastructure, Internet of Things (IoT) devices, monitors, sensors, systems, etc. The ingested data can be internal data, or from one or more external data sources, and can be raw data, processed data, etc. In one or more embodiments, the data is ingested to a data lake 712 for further processing. The data in the data lake can be classified using, for instance, a swarm intelligence-based process. For instance, different classes of data can be categorized into a data catalog, with the data relating, at least in part, to a functional objective being performed and/or to sustainability control. Once data is classified via data classifier 713, one or more data catalogs 714 are obtained, which in one embodiment, are a set of categories of data with different focus groups in different catalogs. In this manner, the data is easier to simplify, with a virtual data model being created 721 from the classified data to represent a simplified version of the input data. Functional objective relation data of the ecosystem 722 can be used to facilitate data normalization of the virtual data model. One embodiment of data normalization is described further below with reference to FIG. 9.

As illustrated in FIG. 7, normalized data is fed to one or more artificial intelligence model(s) 701 to, in part, learn one or more key performance indicators (KPIs) relating performance of the functional objective to sustainability. The artificial intelligence model(s) 701 is trained by a KPI learner process 734 to learn a set of key performance indicators that can be used to, for instance, measure sustainability performance of a system, as well as to correlate performance of a functional objective of the system, or a collection of systems, and overall sustainability control metrics, states or goals. This learned set of dynamic key performance indicators 732 can then be used to facilitate anomaly detection 742 using the artificial intelligence model(s) or layer(s) 701. The anomaly detection process can help to identify an incident and risk for the overall system related to sustainability control and performance of the functional objective. A trainer facility 744 can be used to provide feedback to the key performance indicator learner 734 based on anomaly detection, as well as incident and/or risk impact factor prediction 746. The feedback assists in optimizing the artificial intelligence model(s) 701 for learning the dynamic key performance indicators. In one or more embodiments, a set of natural language processing can be used to establish relationships between an incident, risk and an underlying cause, to generate a root cause analysis for different risks and incidents, which can be used by risk manager code 748 to facilitate generating one or more actions to remediate a risk associated with a detected anomaly. The dynamic set of key performance indicators can be further optimized by the output of the root cause analysis also being fed to the artificial intelligence model(s) used to assist with learning of the dynamic key performance indicators.

In the embodiment illustrated, one or more risks can be fed to an artificial intelligence-based action model 752 trained via an artificial intelligence training facility 754 to generate one or more actions to assist in remediating the risk. The artificial intelligence model(s), in one or more embodiments, leverages the output of the optimized key performance indicators, and the output of the root cause analysis, to identify one or more remediation actions, which can be executed via one or more sustainability control applications 762. A governance intelligence model 756 and governance control 758 can be provided, which can use a set of natural language processing in implementing a governance system to take different actions, such as sending an event to an adjoining system, as well as to the sustainability-related applications 762.

Those skilled in the art will understand from the description provided that, in one or more implementations, disclosed herein is the use of cluster analysis and probability evaluation, swarm intelligence, conditional probability, anomaly detection, and natural language processing, to drive a sustainability control or management process using artificial intelligence modeling. In one or more implementations, the artificial intelligence sustainability model can include swarm intelligence-based clustering, swarm intelligence-based data normalization, corpus linguistics and/or topic modeling, key performance indicator identification optimization, anomaly detection, event-caused mapping, and swarm intelligence-based risk forecasting and/or swarm intelligence-based generation of corrective actions for execution and/or recommendations.

In one or more implementations, the artificial intelligence model(s) (or artificial intelligence sustainability model(s) or swarm intelligence-based sustainability model(s)) described herein receive as input, for instance, a functional objective goal or state for the system, a sustainability objective state or goal for the system, a seed set of key performance indicators from which to learn the set of dynamic key performance indicators over time, and heterogeneous data from multiple data sources related to the functional objective and sustainability. In one or more embodiments, sustainability refers, or relates, to environmental sustainability. In one example, the data sources can provide heterogeneous data relating to, for instance, carbon emission, climate change, supply chain complexity, performance of the functional objective, etc.

In one or more implementations, the artificial intelligence sustainability model(s), or swarm intelligence sustainability model(s), is a self-governing, autonomous system with a variety of capabilities programmed into the model, depending on the particular implementation. For instance, in one or more embodiments, the model is trained to control a sustainability score to a desired level or state, risk detection and forecasting related to sustainability is provided, diagnosis and mitigation for risk and vulnerabilities related to sustainability is provided, execution of corrective actions to maintain, for instance, a sustainability score at a desired level or state is provided, and one or more reports and analysis thereof are provided. In one or more embodiments, the model can facilitate maintaining a functional objective at a desired state or level in combination with facilitating maintaining sustainability at a desired state or objective. Further, in one or more embodiments, a suitable set of dynamic key performance indicators is learned by the model(s) to facilitate controlling sustainability to maintain sustainability at a desired state or level, while also allowing for and ensuring performance of the functional objective to a set performance goal or level.

As discussed herein, in one or more implementations, heterogeneous data is obtained, or referenced, using one or more data collection agents, and analyzed using swarm intelligence-based clustering methods. In one or more embodiments, the heterogeneous data can include log data, functional objective goal data, application data, user activity data, sustainability metrics data, event data, performance data, environmental data, energy consumption data, as well as other heterogeneous data. As noted, from analysis of the data, an artificial intelligence-based sustainability model is derived and/or optimize. Performance of the model can be improved by normalizing the heterogeneous data using, for instance, swarm intelligence-based normalization processing. The artificial intelligence-based model is used to identify a set of dynamic key performance indicators, which can be a broader set of key performance indicators, and to optimize the indicators according to, for instance, a functional objective goal, sustainability goal and/or risk, as well as set metrics. The artificial intelligence-based model is used to retrieve collective intelligence about sustainability performance of an entire system or collection of systems from the knowledge of the multiple data sources. The artificial intelligence-based model is used, in one or more embodiments, to detect an anomaly among the data, such as an event, to identify an incident and associated risk. The artificial intelligence-based model can be used to forecast or predict a risk, or risk event, environmental event, or other parameters. The artificial intelligence-based model described can be used to map an anomaly or an event, to a cause to derive, for instance, corrective action for any incident detected. Further, the artificial intelligence-based model described herein can be used to generate corrective actions, such as notices to an operator, and/or to a governing body to take further action. Further, as noted herein, a variety of corrective actions can be autonomously generated and executed for a selected system or environment. For instance, a maintenance action (e.g., repair, replace, maintain and/or inspect, etc.) specified and an action can be initiated for a selected environment (e.g., a computing environment, a manufacturing environment, a utility environment, a construction environment, etc.). By way of example, an action can be initiated by sending (e.g., automatically based on the generating) an indication to commence the action. As an example, an action can be initiated by a computer (e.g, computer 101 (FIG. 1)), a processor of a processor set (e.g., processor set 110) and/or processing circuitry of a processor set (e.g., processor set 110), to a computing resource, electronic component, device, etc., of the environment, that receives the indication and automatically performs the action.

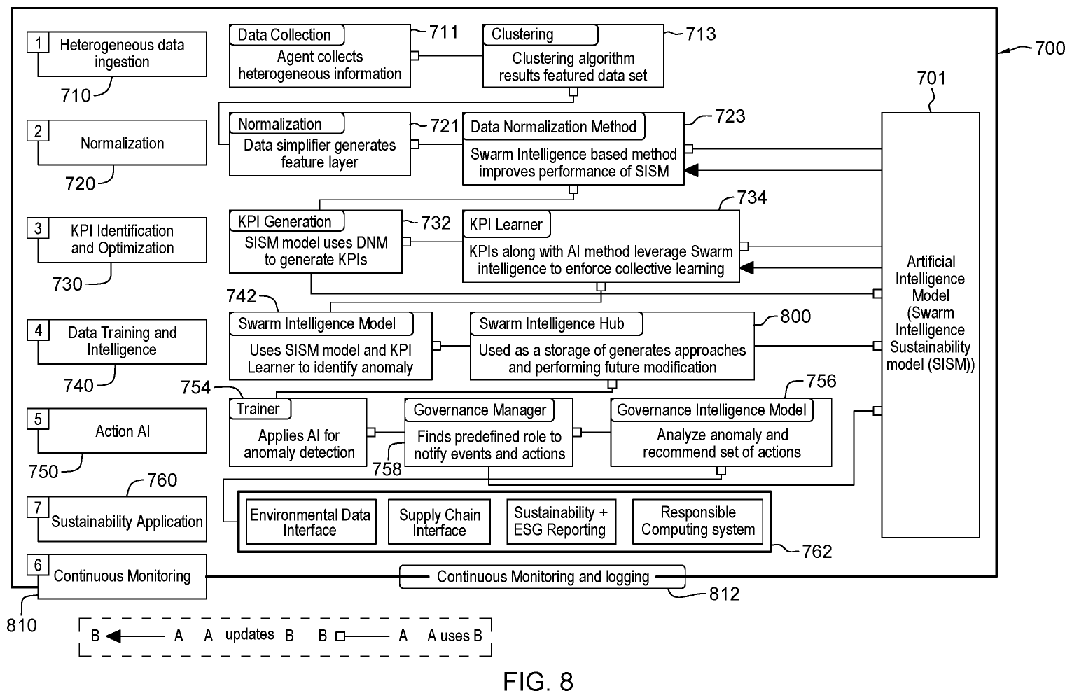

Further details of an embodiment of artificial intelligence-based sustainability control, such as disclosed herein in connection with FIGS. 5-7, are described further below with reference to FIGS. 8-10.

In the example embodiment of FIG. 8, the computing environment with sustainability control processing 700 of FIG. 7 is further illustrated, by way of example. As illustrated, heterogeneous data ingestion layer 710 includes data collection 711, where one or more agents collect heterogeneous information from different sources in different format and structure. In one embodiment, the collected heterogeneous data can be stored in a data lake. The data is not suitable for data analysis as collected, since it is not focused on a single subject matter. As illustrated, the data can be separated into multiple classes and catalogs using one or more clustering algorithms 713, which result in featured datasets that facilitate identifying relationships among the data structures, and facilitates defining a common normalized data format, which can be used for common analysis, for instance, by normalization layer 720. Primary data processing operations in the data lake can classify data into multiple clusters of a data catalog, and by classifying the data into multiple catalogs, identifying similarities and differences among the data is facilitated, which later assists in defining a single, normalized data format for the heterogeneous data.

As illustrated, normalization processing layer 720 includes, in one embodiment, a normalization facility which simplifies the data by generating a virtual data model or feature layer 721, as well as a data normalization process, which can be a swarm intelligence-based process to improve performance of the swarm intelligence sustainability model 723.

FIG. 9 depicts further details of one embodiment of processing performed by heterogeneous data ingestion layer 710 and normalization layer 720, in one example. As illustrated, processing starts 900 with defining an environment of a swarm of systems 902. The systems of the environment are connected to the monitoring system, and each system is referred to as an individual in the swarm 904. Agents are deployed to each swarm system 906 to collect data. The collected data from the individual swarm systems is ingested into a data lake 908, and artificial intelligence agents, in one embodiment, are provided to search for co-relation between data in the data lake from different swarm systems 910.

As noted, data in the data lake can be very different from each other, and normalization can be facilitated by classifying the data into multiple clusters. To facilitate this, an evaluation function ƒ(η), normalized fitness value K=ƒ(η) and optimizing objective function ƒ are defined 912. A data classifier classifies the data based on, in one embodiment, an ant-colony-based algorithm using a strength of pheromone approach 914. The ant colony algorithm, or optimization algorithm, is a probabilistic technique for solving computational problems, which can be reduced to finding good paths through graphs. In this approach, artificial simulation agents locate optimal solutions by moving through a parameter space representing all possible solutions. The simulated agents record their positions (pheromones) and the quality of their solutions, so that in later simulation iterations, better solutions can be located.

As illustrated in FIG. 9, the evaluation function ƒ(η) is used determine the impact of a key performance indicator on each class of data 916, and a set of key performance indicators, along with their corresponding impact on sustainability and functional objective 917, is generated based on the processing. Further, the function ƒ(η) is used to determine the impact of the functional objective goal on each class of data 918, and a data simplifier, or normalizer, then normalizes the data using the fitness value K 920. Processing selects the normalized data (D) where K is maximum 922, and updates the environment information 924, as well as updating the evaluation function (η) 926. Further, the quality of the normalized data (D) can be updated using reinforcement learning 928, where applicable, which completes the data normalization process 930, in one embodiment.

In one or more embodiments, the normalization layer is configured to normalize multi-variable datasets to comparatively normal time series or linear datasets. For instance, the data normalization process can include classifying the heterogeneous data into multiple clusters, as well as identifying functional objective data, for instance, to identify a functional objective goal. The normalization layer can include, in one embodiment, a data simplifier that identifies similar features among different data classes or clusters in the data lake, or data catalog of a previous layer, and constructs a common feature layer. Among uncommon features identified, a relationship can be established or identified based on the relation the features are, and used to construct a second general layer of features in the data structure. Further, among unique, unrelated features in the data classes, a corresponding weight can be assigned, and this weight can be used to determine whether to consider those features, for instance, as noise or not. Assume an example where A, B, C and D are four different classes of data, each of them with some common feature. This common feature can be the first layer of the normalized data. A, B. C and D then have some attributes which are closely related, but not the same. In this case, a meshed version of these features can be used to construct a second layer of the normalized data. For unique features of A, B, C and D, those features with a highest weight value can be selected and combined with the normalized data. In this manner, a feature-based normalization process for the heterogeneous data is performed. The weights can be chosen, for instance, based on impact of the feature, such as based on functional objective impact, or sustainability impact.

The environment or ecosystem for which sustainability control is being provided can include a number of systems, devices, etc., which can be evaluated via an ant colony optimization algorithm. Swarm intelligence is the emergent collective intelligence of groups of simple computer or processing agents. Multiple agents are provided within the environment to continuously monitor the interaction of different systems in the ecosystem. The agents also analyze the exchange of data among the different systems. The agents observe the data generation and analyze the pattern of data flow. This information assists the agents in creating pheromone data for each system that other agents can follow from different systems. This collection of pheromone data produced by the agents from the different systems' input and output can become the set of normalized data, in one embodiment. At the beginning of the normalization process, the agents work to mine data by searching metaheuristic and co-related data. The co-relation can be the basis for the data normalization. In one embodiment, the sustainability control process is provided to:
1. Define the systems for the full stack sustainability infrastructure
2. Set problem parameters
3. Set the seed of KPI
4. Define optimizing objective function f which can generate the relationship of functional goal and KPI
5. Define a heuristic evaluation function (η), which can determine the relationship of KPI and the generated data by any system
6. Define the normalized fitness value K=ƒ(η)
7. While no convergence of swarm do:
   a. Select some swarm individuals
   b. for all selected individuals in swarm do:
      i. Walk through infrastructure effectively exploring new data
      ii. Determine the relationship between current data and the KPI using η which is the pheromone and traverse the pheromone trail (τ) of the data and determine the priority of the data
      iii. Determine the relationship between current data and the functional objective using optimizing objective function ƒ
      iv. Transform the data to a normalized data based on the normalized fitness value K
      v. Generate the strength of the pheromone trail (τ) using the η for the current data generating individuals in swarm
      vi. Based on the strength of the pheromone trail (τ)
         Update space parameters
         Update data set (D) add to the trail
   c. Leverage reinforcement to update evaluation function (η) and the quality of the normalized data
8. End
9. D is the normalized data set.

As discussed, the KPI identification optimization layer 730, data training intelligence layer 740, action AI layer 750, and continuous monitoring layer 810 of the example embodiment of FIG. 8 are knowledge learning layers for the artificial intelligence-based sustainability control disclosed herein. Different layers focus on learning different aspects, such as key performance indicators, incidents, risks, impact, governance, risk mediation actions, and applications. Each of these knowledge aspects learns in a distributed manner. However, since sustainability is dynamic and connects different aspects of the environment, simple distributed learning mechanisms do not work well. Disclosed herein is a collective learning approach, such as one using an ant colony optimization algorithm approach, referred to herein as swarm intelligence-based collective learning, for learning different aspects and improving performance of the learning using collective learning.

Referring further to FIG. 8, the KPI identification and optimization layer 730 includes key performance generation 732, where the artificial intelligence model, or swarm intelligence sustainability model (SISM) uses the normalized data to learn the key performance indicators. In one embodiment, a set of seed key performance indicators can be used as input to the system to control the artificial intelligence models, and the artificial intelligence process to guide the data training. In one or more embodiments, the key performance indicators of the system or environment will depend on the incident, risk, anomaly, governance, and/or environment goals. Initially, a set of seed key performance indicators (or values) can be used for setting up a value for the key performance indicators. Swarm intelligence is then used to learn the set of dynamic key performance indicators relating current performance of the functional objective to sustainability. The key performance indicator learner 734, along with the artificial intelligence model, leverage swarm intelligence to enforce collective learning of the set of dynamic key performance indicators. In one embodiment, the key performance indicator learning model leverages intelligence from the swarm intelligence hub to enforce collective learning. In this manner, the system can learn which key performance indicators are better for system goal, risk, impact identification, and analyzing risk mediating actions. In this layer, the learned key performance indicators can be stored, and shared with, in one embodiment, an end user or subject matter expert who can provide further feedback if the learned key performance indicators are not correct, which helps the system leverage reinforcement learning in the key performance indicator learner model.

By way of further example, a set of key performance indicators can be decorated as a directed graph, where each agent of an ant colony optimization algorithm starts in a start node with a small set of seed key performance indicators, and chooses an edge to follow. The value of the edge is the impact of the corresponding key performance indicator. As the agent explores all individuals in the swarm, new key performance indicators can be found and added to the graph. In addition, the impact of any key performance indicator can change, which results in changing the value/weight of the edge connecting the key performance indictor to the next neighbor or related key performance indicator. In the end, the impact for each key performance indicator will have been learned.

One example process of this approach is to:
1. Initialize a population of particles or KPI with random positions (value) and velocities (impact on business and sustainability), throughout the input space
2. for each particle (here KPI) Ki do
   a. kx=f (Ki)
   b. if kx>impact(ki) then
      i. Ki_{impact}=kx
      ii. pi=ki
   c. end if
   d. g={j|f(pj)=max(f(pk),k∈(Ki))}
3. End for the particles
4. Update velocities (impact on business and sustainability) of Ki
5. Update positions (value) of Ki
6. Updated set of KPI with better knowledge of objective and sustainability.

The artificial intelligence sustainability model(s) (or swam intelligence sustainability model(s)) performs analysis to understand the collective intelligence and leverage that intelligence to learn different aspects individually with the help of the collective knowledge. At the same time, the artificial intelligence system optimizes the swarm intelligence using one or more feedback loops from different connected systems such as facilities, supply chain, environmental data systems, energy consumption control systems, etc. The generated swarm intelligence systems can be stored in a swarm intelligence hub, and be used to update the KPI threshold(s) to reflect real-time dynamic changes in the environment and facilitate maintaining sustainability in a desired state.

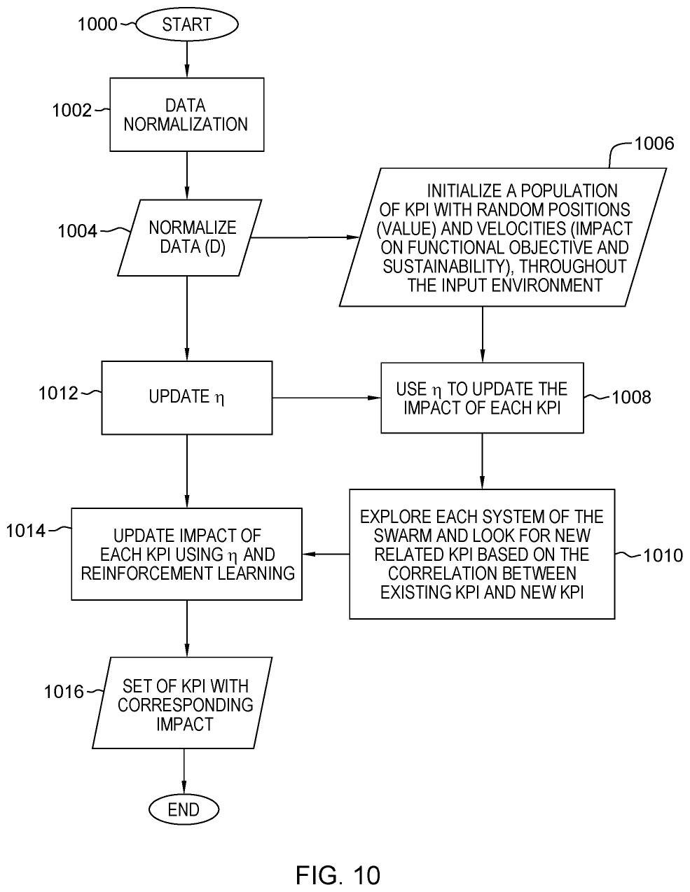

By way of further explanation, FIG. 10 depicts one processing embodiment of KPI identification optimization layer 730, which starts 1000 with obtaining normalized data 1002, with the normalized dataset (D) 1004 being provided as input to initialize a population of key performance indicators with random positions (values) and velocities (impact on functional objective and sustainability) throughout the input environment 1006. The set of normalized data D is also used to update evaluation function η 1012, which in one embodiment, can be used to update the impact of each key performance indicator 1008. Processing explores each system of the swarm, and looks for new related key performance indicators based on the correlation between existing key performance indicator(s) and the new key performance indicator(s) 1010. The impact of each key performance indicator is updated using evaluation function 17 and reinforcement learning 1014 to establish the set of dynamic key performance indicators with corresponding impacts 1016, which completes the process.

As shown in FIG. 8, in one or more embodiments, data training and intelligence layer 740 includes swarm intelligence model processing, which uses artificial intelligence model 701 and the key performance indicator learner to identify any anomaly 742. A swarm intelligence hub 800 is used as a storage to facilitate generating approaches and performing future modification actions by the system.

In one embodiment, data training and intelligence layer 740 learns the pattern of data to learn an anomaly, and understand the difference between a current state and a desired state using artificial-intelligence-based data analysis. Anomaly detection can then be used to assist in identifying incident and non-incident events. As one process example:
a. An incident manager facility stores a found incident.
b. An anomaly can be tagged as the cause for any related incident. The swarm intelligence can be used to run a cause/effect analysis to identify a set of causes for an event anomaly. Each cause of the event can be assigned a risk impact factor to define the impact of that event.
c. The incident data are fed, in one embodiment, to another AI model called Incident/Risk Impact Factor Predictor (R) to forecast a future incident and risk.
d. Risk events and incident events are then separated based on the risk factor associated with each incident. Only events with high risk factors need be considered as a risk.
e. The artificial intelligence layer also identifies potential risks and sends the data to the risk analysis manager.
f. Detected risks can be stored in a risk manager facility, which is used (for instance) in a next layer to identify risk mediating actions.

In one embodiment, events generated in the space are identified and recorded by the agents. Agents can also generate pheromone for each event. The amount of pheromone that an agent deposits on each function can be defined as Eq (1):

pheromone of event i=frequency of event i⊕Risk factor of each event i (1)

In one or more embodiments, the process provides more influence to more frequent events on the distribution of pheromone on the space, while considering the risk factor of the events. The transition rule is defined such that an agent with more frequent events with less risk is more likely to exploit the established pheromone trails, while an agent with less frequent events with more risk tends to explore alternatives. This helps the algorithm with faster change detection, while detecting the risk trend. Agents move from event to event or node to node. Mutual Information is gathered as a measure of similarity between the agents' data from their originating node or event and the data available at the visited node or consequent events. The data at the two nodes is considered highly similar if the mutual information (M) value is larger than the similarity fitness value (S), where:
M=Similarity(pheromone of events of agents), and
S=M. Once the agents find such similar nodes, they directly return to their home node depositing more pheromone (position and quality of solution data) on their path.

As noted, and illustrated in FIG. 8, the artificial intelligence-based sustainability control processing further includes action artificial intelligence layer 750, continuous monitoring layer 810, and sustainability application layer 760.

In one embodiment, one or more natural language processing algorithms can be used to relate a sequence of events that result in a desired state from a current state. The sequence of events can be used to obtain a set of corrective actions to reach a desired state from the current state. As noted, processing applies artificial intelligence for detecting an anomaly 754, and translates the anomaly into a set of intelligent actions to remediate the associated risk in the current environment, and correct the status of one or more different parameters in order to reach a desired state. In one or more implementations, the system executes the one or more actions autonomously to make real-time changes to the system. For instance, in one example, rather than initializing sources, emission factor and others at the beginning of the process, values can be learned over time, and the system autonomously adjusts to make a real-time impact in sustainability to meet, for instance, a desired sustainability state or goal.

In one or more implementations, the action AI layer 750 includes processing where:
a. The artificial intelligence model sorts the set of corrective actions into multiple categories based on the corresponding owner or recipient system of those actions. The owner systems are different systems in the ecosystem such as, supply chain systems, ESG consumption management systems, and others.
b. Once an owner system receives a corresponding set of actions, the system executes the actions autonomously to impact the desired system.
c. The owner systems can also send feedback to the swarm intelligence hub.
d. The owner systems also send feedback to the swarm intelligence hub to update the knowledge, which is later used by the data training and intelligence layer 740.
e. Governance intelligence model 756 analyzes any anomalies to track the progress of sustainability improvement and recommend a set of actions as a roadmap to move to the next level for the desired state.
f. Governance manager code 758 can find a predefined role and user to send a report, event, and/or notification, which can trigger a set of actions to improve the progress of sustainability.

As indicated in FIG. 8, continuous monitoring layer 810 is provided to facilitate feedback for, for instance, reinforcement learning used by the different artificial intelligence models of the sustainability control, including the swarm intelligence model. This monitoring and logging layer can include multiple agents, similar to the ant colony agents described above used to gather knowledge. The agents facilitate continuous monitoring and logging of data 812 for the sustainability control 700.

Sustainability application layer 760 can interface with a variety of sustainability-related applications 762 to, for instance, drive sustainability-related actions generated by the sustainability control. This sustainability application layer 760 can leverage the generated intelligence, and send feedback to the swarm intelligence hub 800 for further improvement of the sustainability control, as described herein.

Those skilled in the art will note from the above description that provided herein are artificial intelligence-based sustainability control methods, systems, and computer program products. In one or more implementations, a heterogeneous data ingestion layer collects data and events from multiple sources and publishes them in a data lake. Primary data processing operations in the data lake classify data into multiple clusters of a data catalog. A normalization layer normalizes the multi-variable datasets to comparatively normal time series or linear datasets. A seed set of key performance indicators is then used as input to the system to initiate the artificial intelligence model(s) and artificial intelligence process to guide the data training. A data artificial intelligence layer performs the analysis to understand one or more anomalies. At the same time, the artificial intelligence system generates swarm intelligence using one or more feedback loops from different connected systems, such as one or more waste management systems, supply chain systems, environmental systems, energy consumption management systems, etc. The generated swarm intelligence can be stored in a swarm intelligence hub. The intelligence is used to update the key performance indicator thresholds to reflect real-time dynamic changes in the environment to facilitate maintaining a desired state. An anomaly is used to understand the difference between the current state and a desired state using artificial intelligence analysis. A set of causes can be identified for a detected anomaly. In one or more embodiments, natural language processing is used in an action artificial intelligence layer to relate the set of causes to a set of corrective actions to facilitate reaching a desired sustainability state from a current sustainability state. In one embodiment, a second artificial intelligence layer stores the set of corrective actions into multiple categories based on the corresponding owner or recipient of the action. The owners are different systems in the ecosystems, such as supply chain systems, ESG consumption management systems, etc. Once a set of actions is identified, the system can execute them autonomously to facilitate reaching the desired state. The owner systems can also send feedback to the swarm intelligence hub to update the knowledge, which is later used by the data artificial intelligence layer. The action artificial intelligence layer is configured to identify potential risk and send notices to the risk analysis manager code. The forecast component of the system uses machine learning, in one embodiment, for use in forecasting, to predict supply/demand/inventory of the system of record, and improve performance. Machine learning can analyze historical data to understand the demand, supply, and inventory, and then forecast future demand, supply, and inventory, in one embodiment. The governance components analyze any anomalies to track the progress of sustainability improvements, and generate recommendations of one or more actions as a roadmap to move to a next level for a desired sustainability state. In one or more embodiments, artificial intelligence models can leverage machine learning to forecast risk.

Provided herein, in one or more embodiments, is an artificial intelligence-based sustainability control system that learns key performance indicators over time using a set of seed key performance indicators, and normalized data with swarm intelligence. The system(s) can interpret a detected anomaly and associate a report in the form of a set of actions, and execute those actions autonomously for better efficiency in system management, risk identification and mitigation, etc. The systems disclosed can learn a current objective, and most feasible objective, over time, using artificial intelligence. The system can interpret reports into a set of autonomous actions and execute those actions automatically, in one or more embodiments. In one embodiment, the system automatically converts an anomaly into an action.

As explained herein, the artificial intelligence-based sustainability control system produces its own key performance indicators. Key performance indicators are not fixed for the platform, but initial seed set of key performance indicators can be provided as input. Over time, rather than inputting weighted values, the system leverages swarm intelligence to automatically learn the best key performance indicators for the environment, and to update the key performance indicators. Advantageously, the system disclosed translates an anomaly into a set of intelligent actions to remediate an associated risk in a current environment, and to correct the status of different parameters in order to reach a desired sustainability state. In one or more implementations, a governance layer is added based on different roles, and the report and action can be explained differently for each role. In one embodiment, natural language processing and artificial intelligence models are used to generate understandable sustainability actions to increase efficiency, and effectiveness of the system. Specific actions are generated for, for instance, specific systems, to address their contribution to a sustainability score or goal within the collection of system(s) or ecosystem(s). This facilitates sustainability control evolving with the environment. The heterogeneous data normalization layer is provided with feedback for effective data quality. The process and data normalization can be controlled and governed by the desired suitability score and key performance indicators through a feedback loop to provide a virtual data model, produce a normalized dataset with fewer dimensions than the input raw data, and to maintain a quality index. Further, an autonomous roadmap can be provided for sustainability score improvement. Artificial intelligence models can be leveraged to identify understandable actions as a roadmap to reach a next level of sustainability heath score. Provided herein is a systemization of sustainability control or management that focuses on real-time actions, which are executed autonomously. The disclosed system is proactive, while also being reactive to making adaptive changes with changes in the environment. The system is also autonomous and self-governed to manage multiple systems that are interacting with each other and impacting the overall sustainability of the collective systems. The swarm intelligence-based autonomous environmental sustainability control system driven by key performance indicators disclosed herein accomplishes these goals.

Other aspects, variations and/or embodiments are possible.

The computing environments described herein are only examples of computing environments that can be used. Other environments may be used; embodiments are not limited to any one environment. Although various examples of computing environments are described herein, one or more aspects of the present invention may be used with many types of environments. The computing environments provided herein are only examples.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other types of neural networks may be considered. Further, other scenarios may be contemplated. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of autonomous sustainability control related to performing a functional objective, the computer-implemented method comprising:
obtaining normalized data from heterogeneous data obtained from a plurality of data sources, the heterogeneous data relating, at least in part, to the functional objective;
training, using the normalized data, an artificial intelligence model to learn dynamic key performance indicators relating, at least in part, performance of the functional objective to sustainability;
using the artificial intelligence model to learn a set of dynamic key performance indicators to relate current performance of the functional objective to sustainability;
identifying, using the learned set of dynamic key performance indicators, an anomaly; and
generating one or more actions to remediate a risk associated with the anomaly, the one or more actions facilitating the autonomous sustainability control related to performing the functional objective.

2. The computer-implemented method of claim 1, wherein the obtaining comprises classifying, at least in part, the heterogeneous data into classified data.

3. The computer-implemented method of claim 2, wherein the obtaining further comprises normalizing the classified data by:
simplifying the classified data and generating a virtual data model representative of a simplified version of the heterogeneous data; and
normalizing the virtual data model using, at least in part, functional objective relation data.

4. The computer-implemented method of claim 1, wherein the identifying further comprises:
using the learned set of dynamic key performance indicators to detect an anomaly in the normalized data; and
based on detecting the anomaly, identifying an incident and predicting an associated risk related to sustainability and performance of the functional objective.

5. The computer-implemented method of claim 4, further comprising automatically establishing a relationship between the incident, the predicted risk, and an underlying cause to generate a root cause analysis for one or more different risks and incidents.

6. The computer-implemented method of claim 5, further comprising optimizing the artificial intelligence model by, at least in part, feeding identification of the incident back to the training of the artificial intelligence model to optimize learning of the set of dynamic key performance indicators.

7. The computer-implemented method of claim 5, further comprising optimizing the artificial intelligence model by, at least in part, feeding an output of the root cause analysis back to the training of the artificial intelligence model to optimize learning of the set of dynamic key performance indicators.

8. The computer-implemented method of claim 7, wherein generating the one or more actions comprises using the output of the root cause analysis and the learned set of dynamic key performance indicators to autonomously generate the one or more actions.

9. The computer-implemented method of claim 1, further comprising executing autonomously the one or more actions to make one or more real-time changes to remediate the risk and facilitate reaching a desired sustainability state.

10. The computer-implemented method of claim 1, wherein the heterogeneous data is obtained from a plurality of systems, where the normalized data is obtained with swarm intelligence.

11. A computer system for facilitating autonomous sustainability control related to performing a functional objective, the computer system comprising:
a memory; and
at least one processor in communication with the memory, wherein the computer system is configured to perform a method, the method comprising:
obtaining normalized data from heterogeneous data obtained from a plurality of data sources, the heterogeneous data relating, at least in part, to the functional objective;
training, using the normalized data, an artificial intelligence model to learn dynamic key performance indicators relating, at least in part, performance of the functional objective to sustainability;
using the artificial intelligence model to learn a set of dynamic key performance indicators to relate current performance of the functional objective to sustainability;
identifying, using the learned set of dynamic key performance indicators, an anomaly; and
generating one or more actions to remediate a risk associated with the anomaly, the one or more actions facilitating the autonomous sustainability control related to performing the functional objective.

12. The computer system of claim 11, wherein the identifying further comprises:
using the learned set of dynamic key performance indicators to detect an anomaly in the normalized data; and
based on detecting the anomaly, identifying an incident and predicting an associated risk related to sustainability and performance of the functional objective.

13. The computer system of claim 12, further comprising automatically establishing a relationship between the incident, the predicted risk, and an underlying cause to generate a root cause analysis for one or more different risks and incidents.

14. The computer system of claim 13, wherein generating the one or more actions comprises using an output of the root cause analysis and the learned set of dynamic key performance indicators to autonomously generate the one or more actions.

15. The computer system of claim 11, further comprising executing autonomously the one or more actions to make one or more real-time changes to remediate the risk and facilitate reaching a desired sustainability state.

16. The computer system of claim 11, wherein the heterogeneous data is obtained from a plurality of systems, where the normalized data is obtained with swarm intelligence.

17. A computer program product for facilitating autonomous sustainability control related to performing a functional objective, the computer program product comprising:
one or more computer readable storage media and program instructions collectively stored on the one or more computer readable storage media readable by at least one processing circuit to perform a method comprising:
obtaining normalized data from heterogeneous data obtained from a plurality of data sources, the heterogeneous data relating, at least in part, to the functional objective;
training, using the normalized data, an artificial intelligence model to learn dynamic key performance indicators relating, at least in part, performance of the functional objective to sustainability;
using the artificial intelligence model to learn a set of dynamic key performance indicators to relate current performance of the functional objective to sustainability;
identifying, using the learned set of dynamic key performance indicators, an anomaly; and
generating one or more actions to remediate a risk associated with the anomaly, the one or more actions facilitating the autonomous sustainability control related to performing the functional objective.

18. The computer program product of claim 17, wherein the identifying further comprises:
using the learned set of dynamic key performance indicators to detect an anomaly in the normalized data; and
based on detecting the anomaly, identifying an incident and predicting an associated risk related to sustainability and performance of the functional objective.

19. The computer program product of claim 18, further comprising automatically establishing a relationship between the incident, the predicted risk, and an underlying cause to generate a root cause analysis for one or more different risks and incidents.

20. The computer program product of claim 17, wherein generating the one or more actions comprises using an output of the root cause analysis and the learned set of dynamic key performance indicators to autonomously generate the one or more actions.
